(19) United States
(12) Patent Application Publication
(10) Pub. No.: US 2010/0169629 A1
(43) Pub. Date: Jul. 1, 2010

(54) METHOD FOR CONFIGURING COMPUTER BY BIOS, SERVER, COMPUTER, SYSTEM STARTUP METHOD AND COMPUTER SYSTEM

(75) Inventors: Jianhui Zhang, Beijing (CN); Haibin Ke, Beijing (CN)

Correspondence Address: DICKSTEIN SHAPIRO LLP, 1633 Broadway, NEW YORK, NY, 10019, US

(73) Assignee: Lenovo (Beijing) Limited, Beijing (CN)

(21) Appl. No.: 12/648,173

(22) Filed: Dec. 28, 2009

(30) Foreign Application Priority Data
Dec. 31, 2008 (CN) 200810247488.2
Jan. 4, 2009 (CN) 200910076482.8

(51) Int. Cl. G06F 15/177

(52) U.S. Cl. 713/1

(57) ABSTRACT

A method for configuring computer by Basic Input/Output System (BIOS), a server and a computer are provided. The method comprising the steps of: setting up a connection to a server storing configuration information for the computer through a network; acquiring the configuration information for the computer from the server; and configuring the computer based on the configuration information. With the solutions according to the embodiments of the present invention, it is convenient in setting the configuration information, especially for the case where it is required to set the configuration information for a number of computers. In this way, the labor efficiency can be effectively improved and the security of the configuration information can be effectively enhanced.

### FIELD OF THE INVENTION

The present invention relates to the field of computer technology, and more particularly, to a method for configuring computer by Basic Input Output System (BIOS), a server, a computer, a system startup method and a computer system.

### BACKGROUND OF THE INVENTION

Generally, a computer device, such as a computer, is provided with a BIOS program, which is mainly used for directly controlling computer hardware and performing the most basic initialization processes on the computer.

In operation of the BIOS program, configuration information is typically used. In general, the computer is provided with preset values for the configuration information. However, the configuration information is usually required to be set such that the operation result of the BIOS program can satisfy specific requirements.

In the prior art, for a particular computer, it is typically required to set the configuration information on the computer and store the set BIOS configuration information in a storage medium, such as CMOS, flash or other flash area, of the computer. The computer is typically referred to as local computer.

In implementation of the present invention, the inventor searched at least the following problems in the prior art. According to the prior art, in configuring a computer based on a BIOS program, there may be at least two aspects of problems with respect to the case where the configuration information is locally set and locally stored.

The first aspect consists in that, in practice, the storage medium for locally storing the configuration information is typically in an open state, such that the stored configuration information is vulnerable to illegal modification.

The second aspect consists in that the process for setting the configuration information is typically troublesome when it is required, e.g., the configuration information is required to be reset if it has been illegally modified. For example, an administrator responsible for setting the configuration information needs to go onto respective computers to perform the corresponding setting. Further, for the case where the administrator is geographically remote from the computer, the administrator is required to set the configuration information for the computer remotely, which requires the computer being set is in a power-on state such that the administrator can acquire relevant information. Further, a remote setting tool developed for specific situations is typically necessary. Thus, the process for setting the configuration information is troublesome and costly.

Therefore, in configuring a computer based on a BIOS program in the prior art, the technical solution in which the configuration information is locally set and locally stored results in both inconvenience in setting the configuration information and difficulty in ensuring security of the configuration information.

The BIOS is underlying codes which directly interact with hardware and provide an operating system with the basic function for controlling hardware devices. The BIOS includes a system BIOS (which is generally referred to as main board BIOS), a graphics card BIOS and BIOSs for other devices (such as IDE controller, SCSI card or network card). Herein, the startup process of the computer is performed under the control of the system BIOS. In general, the BIOS is stored in a non-volatile memory/memory chip, such that these codes will not be lost even if the computer is turned off or powered off.

The BIOS stores therein programs for basic input/output, system setting information, a power on self test program and a system startup bootstrap program, which are all important to the computer. In the startup process of the computer, it is necessary to acquire program instructions required for startup from the BIOS.

However, as the functions of the computer system are increasingly powerful, there is an increasing amount of instructions to be acquired from the BIOS during system startup. Thus, the size of the BIOS is increasingly larger, which results in that the capacity of the memory device dedicated for storing the BIOS has to be increased accordingly.

### SUMMARY OF THE INVENTION

The embodiments of the present invention provides a method for configuring a computer by BIOS, a server and a computer, capable of overcoming the technical problem in the prior art with respect to the relative insecurity of the configuration information and the inconvenience in setting the configuration information.

Another object of the embodiments of the present invention is to provide a system startup method and a computer system, capable of reducing capacity of memory device dedicated for storing BIOS in the computer system.

To solve the above technical problem, a method for configuring a computer by BIOS is provided, which comprises the following steps of:

setting up a connection to a server storing configuration information for the computer through a network;

acquiring the configuration information for the computer from the server; and

configuring the computer based on the configuration information.

Preferably, the step of acquiring the configuration information for the computer from the server comprises:

receiving the configuration information transmitted by the server.

Preferably, the method further comprises, prior to the step of receiving the configuration information transmitted by the server, the step of:

transmitting to the server a request message for requesting acquisition of the configuration information, the request message including a computer identification for identifying the computer.

Preferably, the step of configuring the computer based on the configuration information comprises:

storing the configuration information temporarily; and

invoking the temporarily stored configuration information to configure the computer.

Preferably, the method further comprises, after the step of invoking the temporarily stored configuration information to configure the computer, the step of:

releasing the temporarily stored configuration information.

Preferably, the step of configuring the computer based on the configuration information comprises:

storing the configuration information in a preset storage medium; and

invoking the configuration information from the storage medium to configure the computer.

Preferably, the step of invoking the configuration information from the storage medium to configure the computer comprises:

invoking, during the current startup of the computer, the configuration information to configure the computer; or

invoking, during the next startup of the computer, the configuration information to configure the computer.

To solve the above technical problem, a server is further provided, which comprises:

a first connection setup unit configured to set up a connection to a computer;

a storage unit configured to store configuration information for configuring the computer by BIOS; and

a data providing unit configured to provide the configuration information for the computer as stored in the storage unit to the computer via the connection set up by the first connection setup unit.

Preferably, the data providing unit comprises:

a first transmission processing unit configured to transmit the configuration information stored in the storage unit to the computer.

Preferably, the data providing unit comprises:

a reception processing unit configured to receive, via the connection, and process a request message transmitted by the computer for requesting acquisition of the configuration information for the computer; and

a second transmission processing unit configured to transmit, based on the request message received by the reception processing unit, the configuration information stored in the storage unit as requested by the computer to the computer via the connection.

Preferably, the reception processing unit comprises:

a reception unit configured to receive, via the connection, the request message transmitted by the computer for requesting acquisition of the configuration information; and

an identification acquisition unit configured to parse the computer identification for identifying the computer from the request message received by the reception unit.

Preferably, the second transmission processing unit comprises:

a search unit configured to search the configuration information applicable to the computer based on the computer identification acquired by the identification acquisition unit; and

a transmission unit configured to transmit the configuration searched by the search unit to the computer via the connection.

To solve the above technical problem, a computer is further provided, which comprises:

a second connection setup unit configured to set up a connection to a server storing configuration information for configuring the computer by BIOS;

an obtaining unit configured to acquire the configuration information from the server via the connection set up by the second connection setup unit; and

a configuration unit configured to configure the computer based on the configuration information acquired by the obtaining unit.

Preferably, the obtaining unit comprises:

an information reception unit configured to receive the configuration information transmitted by the server via the connection.

Preferably, the obtaining unit further comprises:

a request transmission unit configured to transmit, via the connection, a request message to the server for requesting acquisition of the configuration information, the request message including a computer identification for identifying the computer; and

an information reception unit configured to receive the configuration information.

Preferably, the computer further comprises:

a storage module configured to store the configuration information acquired by the obtaining unit, wherein the configuration unit is configured to invoke the configuration information from the storage module for configuring the computer.

Preferably, the computer further comprises:

a release unit configured to release the configuration information stored in the storage module after the configuration unit configures the computer.

Preferably, the second connection setup unit and the obtaining unit are arranged in a specified system in the computer.

Preferably, the computer further comprises:

a command transmission unit configured to transmit a command to the specified system for requesting the configuration information required by the configuration unit;

wherein the specified system comprises a command reception unit configured to receive and execute the command.

The solutions according to the embodiments of the present invention have the following advantageous effects compared with the prior art.

With the method for configuring computer by BIOS, the server and the computer according to the embodiments of the present invention, the configuration information required by the computer is set on the server and then acquired by the computer from the server. Thus, it is more convenient in setting the configuration information, especially for the case where it is required to set the configuration information for a number of computers. In this way, the labor efficiency can be effectively improved.

Additionally, as the acquired configuration information can be temporarily stored in the computer, e.g., in a memory of the computer, the temporarily stored configuration information can be released after the operation of the BIOS program based on the configuration information is completed. In this way, the storage resource can be effectively saved. The storage medium for storing the configuration information, such as COMS and flash, can even be omitted in the computer for lack of resources.

Further, the configuration information is stored at the server end. Thus, in the case where the computer does not store the configuration information, it is difficult for a malicious access to illegally modify the configuration information applicable to the computer even if it can access the computer. Thus, the security of the configuration information can be effectively enhanced. On the other hand, in the case where the computer stores the configuration information, the computer can conveniently acquire the relevant configuration information from the server end again even if a malicious access has illegally modified the configuration information, without requiring the administrator to reset the relevant configuration information on the computer locally. In this way, the repetitive efforts by the administrator can be effectively avoided.

To solve the above technical problem, the embodiments of the present invention provide a system startup method, a computer terminal and a computer system as follows.

A system startup method is provided, which is applied to a computer system comprising a primary system and an auxiliary system, wherein a BIOS program required for startup of the primary system is stored in a device on a network, the method comprising:

obtaining, by the auxiliary system, the BIOS program from the device through the network;

storing the BIOS program in the auxiliary system;

receiving, by the primary system, a power-on signal;

enabling, by the primary system, an initialization program for implementing communication function;

loading, by the primary system, the BIOS program from the auxiliary system by using the initialization program; and

starting up, by the primary system, the primary system using the BIOS program.

A system startup method is provided, which is applied to a computer system comprising a primary system and an auxiliary system, a BIOS program required for startup of the primary system being stored in a device on a network, wherein the primary system and the auxiliary system are both connected to a storage, the auxiliary system, after obtaining in advance the BIOS from the device and storing it in the storage, maps an address in a primary system memory for loading the BIOS to an address in the storage for the downloaded BIOS and switches read/write function of the storage to the primary system, the method comprising:

receiving, by the primary system, a power-on signal and performing system startup by reading the BIOS stored in the storage based on the mapping relationship between the BIOS program in the primary system memory and the BIOS stored in the storage.

A computer system is provided, which is connected through a network to a device on the network, the device having a BIOS program stored therein, the computer system comprising:

a primary system comprising a memory and an initialization module for implementing communication function; and

an auxiliary system comprising a network connection module for obtaining the BIOS program from the device through the network and a storage module for storing the BIOS program;

wherein the primary system starts up the primary system using the BIOS program after loading the BIOS program into the memory by using the initialization module.

A computer system is provided, which comprises a primary system, an auxiliary system and a storage, wherein the system is connected through a network to a device on the network, the device having a BIOS program stored therein, the system comprising:

the auxiliary system, comprising:
a network connection unit configured to obtain the BIOS from the device and store it in the storage;
a mapping unit configured to map an address in a primary system memory for loading the BIOS to an address in the storage for the downloaded BIOS; and
a switching unit configured to switch read/write function of the storage to the primary system;

the storage configured to store the BIOS obtained by the auxiliary system from the device; and

the primary system comprising a memory and an initialization module for implementing communication function;

wherein the primary system starts up the primary system using the BIOS program after loading the BIOS program into the memory by using the initialization module.

It can be seen from the solutions according to the embodiments of the present invention that the auxiliary system downloads in advance the BIOS from the server and stores it; the primary system receives a power-on signal and enables an initialization program for implementing communication function; the primary system loads the BIOS program from the auxiliary system into the primary system memory by using the initialized communication function; and the primary system starts up the system using the BIOS program loaded into the memory. In this way, the capacity of the memory device dedicated for storing system BIOS in the primary system can be reduced.

### BRIEF DESCRIPTION OF THE DRAWINGS

FIG. 1 is a flowchart showing the method for configuring computer by BIOS according to an embodiment of the present invention.

FIG. 2 is a schematic diagram showing the structure of the server according to an embodiment of the present invention.

FIG. 3 is a schematic diagram showing the structures of a reception processing unit 2031 and a second transmission processing unit 2032 according to an embodiment of the present invention.

FIG. 4 is a schematic diagram showing the structure of the computer according to an embodiment of the present invention.

FIG. 5 is a flowchart showing an example of configuring the computer according to an embodiment of the present invention.

FIG. 6 is a flowchart showing another example of configuring the computer according to an embodiment of the present invention.

FIG. 7 is a flowchart showing an example of obtaining configuration information by a computer according to an embodiment of the present invention.

FIG. 8 is a flowchart showing a process in which a BIOS program acquires configuration information from an auxiliary system 702 according an embodiment of the present invention.

FIG. 9 is a flowchart showing the first embodiment of the method according to the present invention.

FIG. 10 is a block diagram showing the first embodiment of the system according to the present invention.

FIG. 11 is a block diagram showing the second embodiment of the system according to the present invention.

### DETAILED DESCRIPTION OF THE PREFERRED EMBODIMENTS

The reason for the inconvenience in setting the configuration information in the prior art is in that the configuration information is locally set according to the prior art. Thus, in some cases, if an administrator needs to manage a plurality of computers, sometimes he will have to perform the same configuration on different computers. Since the setting has to be performed locally, a large amount of repetitive efforts by the administrator are required, with low labor efficiency. Further, if the setter is geographically remote from the computer, it will be very inconvenient for him to set the configuration information.

The embodiments of the present invention allow for setting and storing the configuration information for the computer at a server, such that its security can be relatively improved and its setting can be facilitated.

In the following, the solutions according to the embodiments of the present invention will be detailed with reference to the embodiments and drawings.

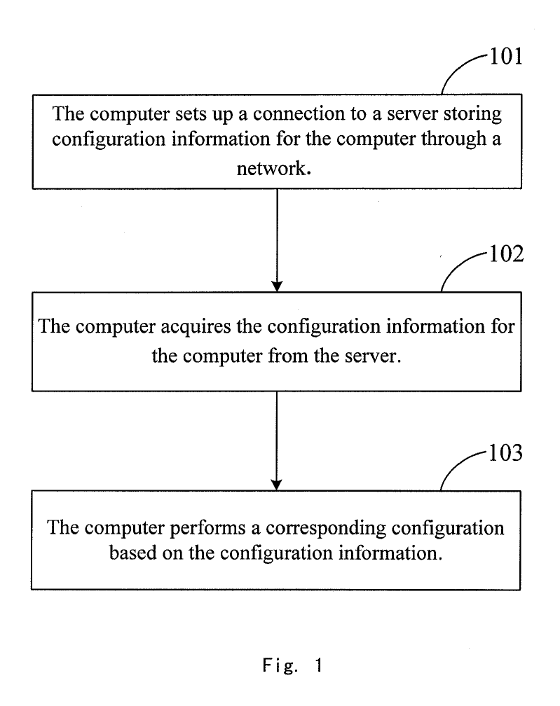

Reference is now made to FIG. 1, which is a flowchart of the method according to an embodiment of the present invention. The flow comprises the following steps.

At step 101, a computer sets up a connection to a server storing configuration information for a computer through a network.

At step 102, the computer acquires the configuration information for the computer from the server.

At step 103, the computer performs a corresponding configuration based on the configuration information.

In the flow as shown in FIG. 1, the configuration information is not directly set on the computer that requires the configuration information directly, but is set on the server instead. Then, the computer acquires the configuration information from the server as desired, such that the setting of the configuration information can be facilitated.

In particular, the administrator may set on the server the configuration information applicable to the computer, e.g., the administrator may set a set of configuration information applicable to one or more computers or a number of sets of configuration information applicable to a number of computers, respectively. In this way, compared with the prior art, the setting of the configuration information applicable to the computer becomes much more efficient and the workload of the administrator can be greatly reduced, thereby effectively improving labor efficiency.

According to the embodiment of the present invention, the configuration information can be provided, e.g., pushed, to the computer by the server when the connection between the server and the computer is set up. As an alternative, the computer can transmit, when required to acquire the configuration information, a request message for requesting acquisition of the configuration information to the server. Further, the identification of the computer can be set in the request message. On receipt of the request message, the server searches the configuration information applicable to the computer based on the identification of the computer and then transmits the searched configuration information to the computer. Thus, in the process in which the BIOS program operates to accomplish relevant functions, such as Power On Self Test (POST), relevant configuration operations can be performed based on the obtained configuration information.

Further, according to the embodiment of the present invention, on receipt of the configuration information, the computer can be set to store the configuration information temporarily, depending on the resource usage within the computer, in a memory for example. The temporarily stored configuration information can be released once it is used by the BIOS program to accomplish relevant operations, and can be acquired from the server again as desired subsequently. In this way, the storage resource required for storing the configuration information can be effectively saved. The storage medium for storing the configuration information, such as COMS and flash, can even be omitted in the computer in case of lack of resources.

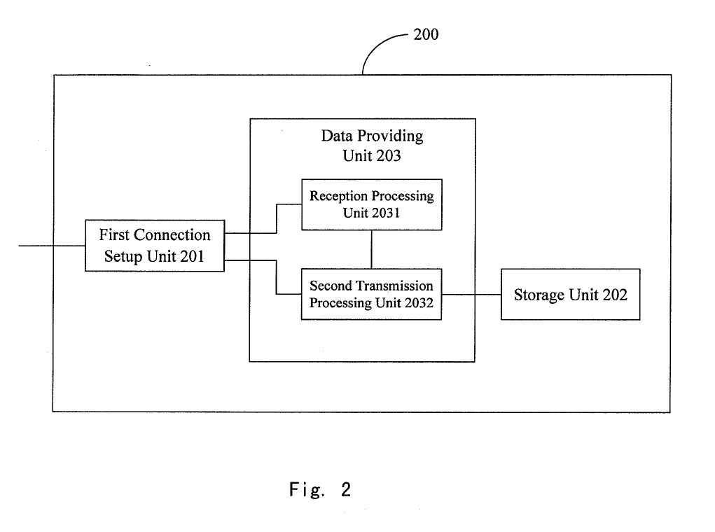

The embodiment of the present invention further provides a server. Reference is now to FIG. 2, which is a schematic diagram showing the structure of the server. In addition to functions of a common server, the server 200 can further comprise a first connection setup unit 201, a storage unit 202 and a data providing unit 203.

Herein, the first connection setup unit 201 is configured to set up a connection between the server and a computer. The function of the first connection setup unit 201 can be implemented based on existing technologies for connection between the computer and the server. In practice, the connection between the computer and the server according to the present invention can be set in case of availability of resource, such that it can be determined by default that the configuration information is required to transmitted between the computer and the server as long as the computer accesses the server via the connection or vice versa.

The storage unit 202 is configured to store configuration information for configuring the computer by BIOS.

The data providing unit 203 is configured to provide the configuration information stored in the storage unit 202 to the computer via the connection set up by the connection setup unit 201.

In FIG. 2, the data providing unit 203 can comprise a reception processing unit 2031 and a second transmission processing unit 2032.

Herein, the reception processing unit 2031 is configured to receive, via the connection between the server and the computer, a request message transmitted by the computer for requesting acquisition of the configuration information.

The second transmission processing unit 2032 is configured to transmit, based on the request message received by the reception processing unit 2031, the configuration information stored in the storage unit 202 as requested by the computer to the computer via the connection between the server and the computer.

In practice, the data providing unit 203 can be configured to comprise only a first transmission processing unit (not shown in FIG. 2), which can push the configuration information stored in the storage unit 202 directly to a corresponding computer as required by network.

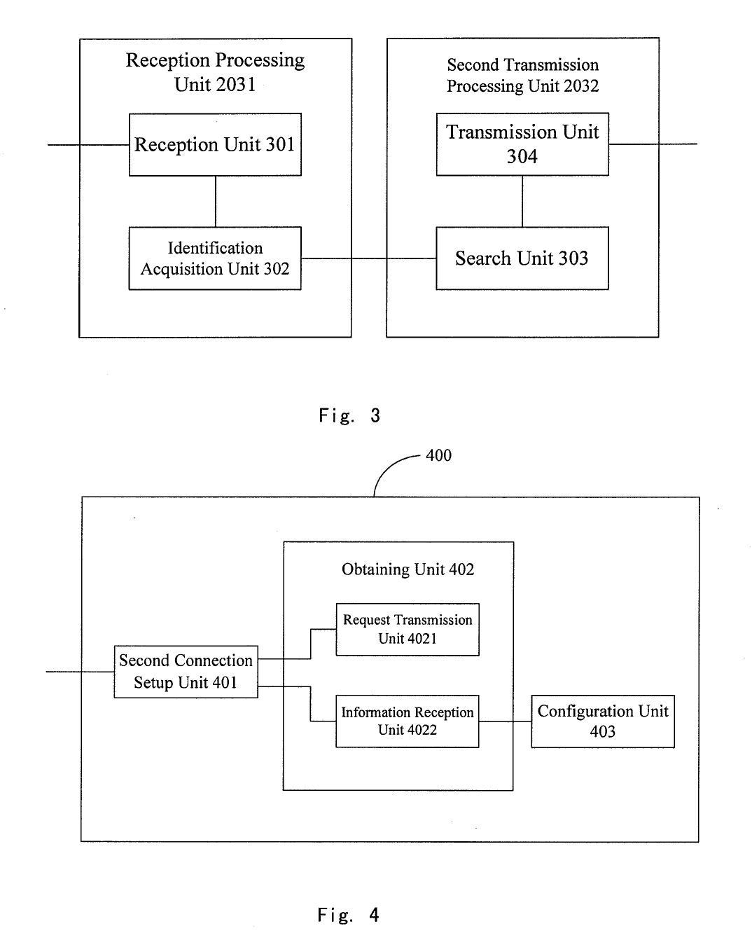

Reference is now made to FIG. 3, which is a schematic diagram showing the structures of the reception processing unit 2031 and the second transmission processing unit 2032 according to an embodiment of the present invention.

In FIG. 3, the reception processing unit 2031 can comprise a reception unit 301 and an identification acquisition unit 302.

Herein, the reception unit 301 is configured to receive, via the connection between the server and the computer, the request message transmitted by the computer for requesting acquisition of the configuration information.

The identification acquisition unit 302 is configured to parse the identification of the computer from the request message received by the reception unit 301.

The second transmission processing unit 2032 comprises a search unit 303 and a transmission unit 304.

Herein, the search unit 303 is configured to search the configuration information applicable to the computer based on the identification acquired by the identification acquisition unit 302. In a particular implementation, in the case where one server provides configuration information to more than one computer, match information between the identifications of the computers and the configuration information can be preset in the server. Thus, the search unit 303 can find the BIOS configuration information applicable to the computer based on the match information and the obtained identification of the computer.

The transmission unit 304 is configured to transmit the configuration searched by the search unit 303 to the computer via the connection between the server and the computer.

Reference is also made to FIG. 4, which is a schematic diagram showing the structure of the computer according to an embodiment of the present invention. In FIG. 4, the computer 400 may comprise a second connection setup unit 401, an obtaining unit 402 and a configuration unit 403.

Herein, the second connection setup unit 401 is configured to set up a connection to a server which stores configuration information for configuring the computer by BIOS.

The obtaining unit 402 is configured to acquire the configuration information from the server to which the connection is set up by the second connection setup unit 401.

The configuration unit 403 is configured to configure the computer based on the configuration information acquired by the obtaining unit 402.

In FIG. 4, the obtaining unit 402 may comprise an information reception unit 4021 and possibly a request transmission unit 4022.

Herein, the request transmission unit 4022 is configured to transmit, via the connection between the computer and the server, a request message to the server for requesting acquisition of the configuration information.

The information reception unit 4021 is configured to receive the configuration information transmitted by the server via the connection between the computer and the server.

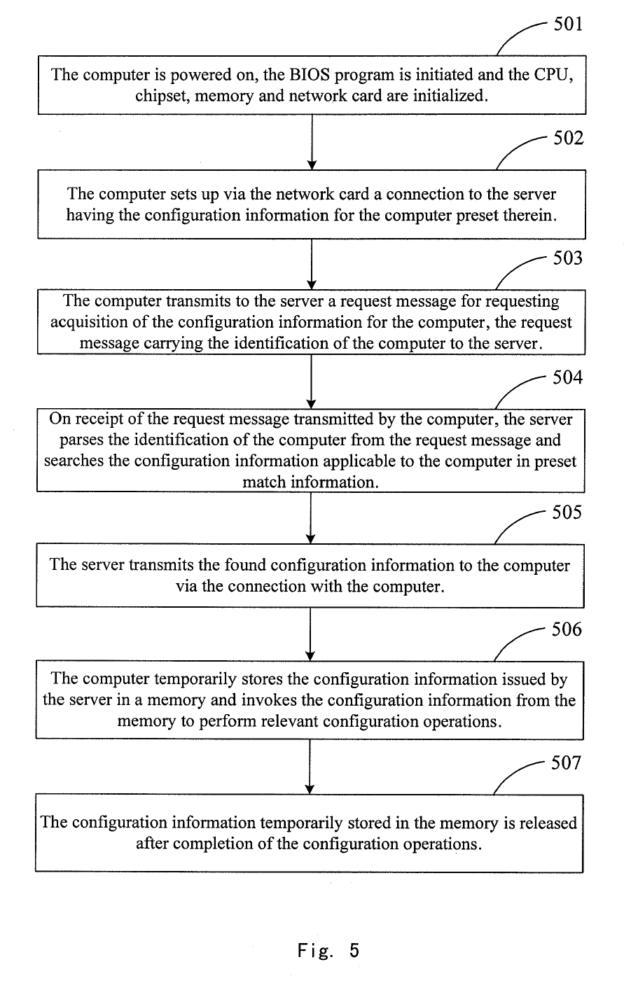

Reference is now made to FIG. 5, which is a flowchart showing an example of configuring the computer according to an embodiment of the present invention. The flow acquires configuration information during initiation of a BIOS program and can comprise the following steps.

At step 501, the computer is powered on, the BIOS program is initiated and the CPU, chipset, memory and network card are initialized.

The above step 501 relates to achievable prior art.

At step 502, the BIOS program sets up via the network card a connection to the server having the configuration information for the computer preset therein.

At step 503, the BIOS program transmits to the server a request message for requesting acquisition of the configuration information for the computer, the request message carrying the identification of the computer to the server.

At step 504, on receipt of the request message transmitted by the computer, the server parses the identification of the computer from the request message and searches the configuration information applicable to the computer based on the preset match information.

At step 505, the server transmits the searched configuration information to the computer via the connection with the computer.

At step 506, the BIOS program temporarily stores the configuration information issued by the server in a memory and extracts the configuration information from the memory to perform relevant configuration operations.

At step 507, the configuration information temporarily stored in the memory is released after completion of the configuration operations.

The flow shown in FIG. 5 is thus ended.

In practice, by executing the BIOS program, the computer hardware system can be initialized and the operating system (OS) can thus be loaded.

According to the above flow shown in FIG. 5, the configuration information is temporarily stored in the memory and is released after accomplishing the operation of the BIOS program, such that the usage of the storage resource in the computer can be effectively saved.

Since the configuration information can be set on the server, a data setter (such as an administrator) can, when appropriate, conveniently set the configuration information for the computer on the server as desired in some cases where, for example, the configuration information is to be updated as, for example, the BIOS program is updated or the requirement of the computer user is changed. Then, since the configuration information can be acquired from the server, the updated configuration information can be acquired by the computer in a timely manner, such that the user requirement can be satisfied and the user experience can be improved.

Moreover, in practice, in addition to acquiring the configuration information during initiation of the BIOS program as shown in the FIG. 5, the process for acquiring the configuration information can also be implemented during system update for the operation system, such as a Windows system.

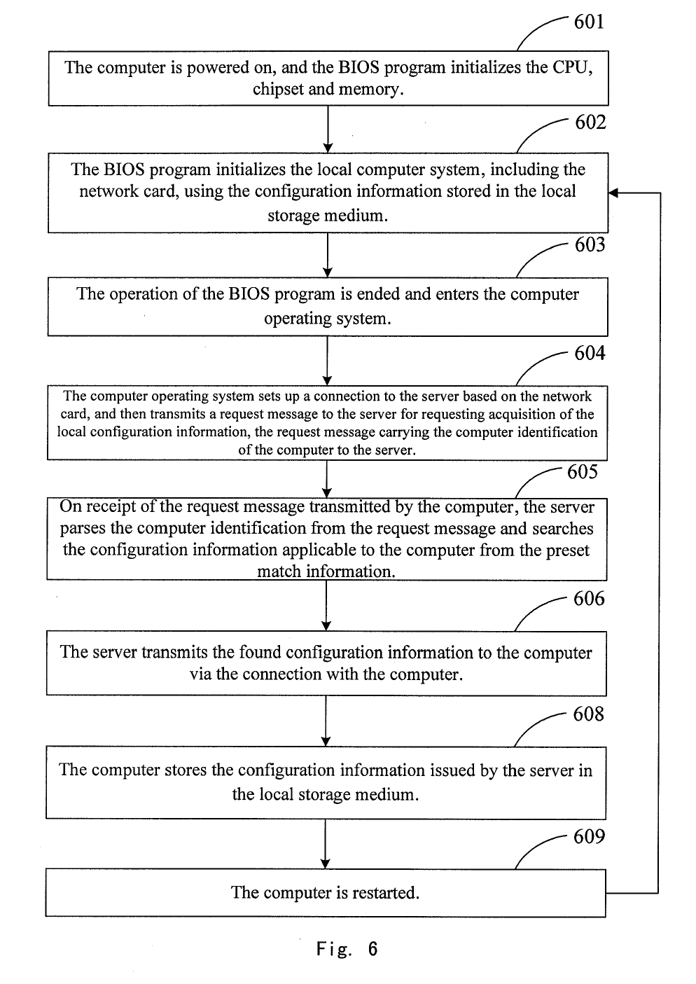

Reference is now made to FIG. 6, which is a flowchart showing another example of configuring the computer according to an embodiment of the present invention. The computer is in particular a computer. The flow may comprise the following steps.

At step 601, the computer is powered on, and the BIOS program initializes the CPU, chipset and memory.

At step 602, the BIOS program initializes the local computer system, including the network card, using the configuration information stored in the local storage medium.

In practice, the configuration information stored in the local storage medium can be obtained from the server.

At step 603, the operation of the BIOS program is ended and enters the computer operating system.

The flow of the above steps 601 to 603 is similar to the relevant flow in the prior art.

At step 604, the computer operating system sets up a connection to the server based on the network card, and then transmits a request message to the server for requesting acquisition of the local configuration information, the request message carrying the computer identification of the computer to the server.

At step 605, on receipt of the request message transmitted by the computer, the server parses the computer identification from the request message and searches the configuration information applicable to the computer from the preset match information.

At step 606, the server transmits the searched configuration information to the computer via the connection with the computer.

At step 607, the computer stores the configuration information issued by the server in the local storage medium.

At step 608, the computer is restarted and returns to step 602.

The flow shown in FIG. 6 is ended here.

In the flow shown in FIG. 6, acquisition of the configuration information by the computer is accomplished before operation of the BIOS program, such that the operation efficiency of the BIOS program can be effectively improved.

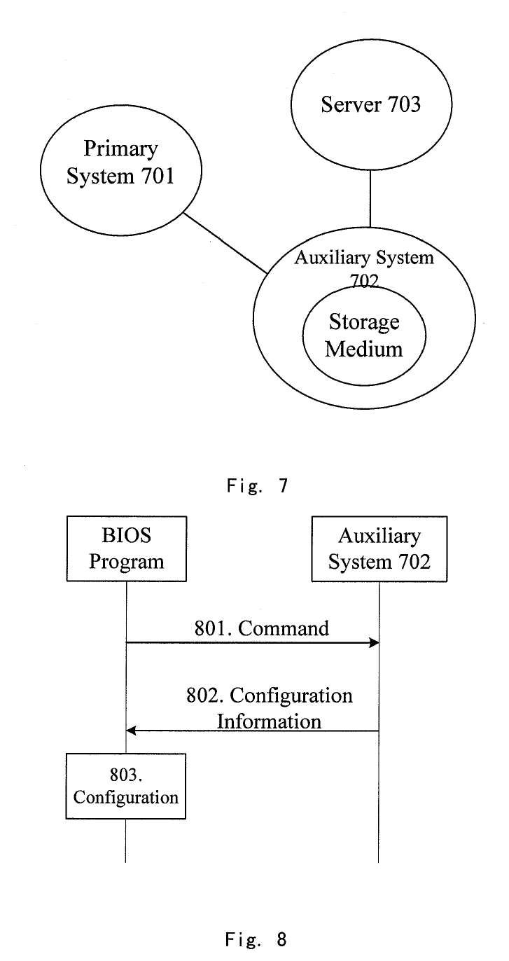

Reference is now made to FIG. 7, which is a flowchart showing an example of obtaining configuration information by a computer according to an embodiment of the present invention. The computer comprises a primary system 701 and an auxiliary system 702. The primary system 701 typically operates after the computer is turned on; and the auxiliary system 702 is capable of operating in an environment in which the computer is turned off but not powered off. Examples of computer technologies with the auxiliary system 702 comprise for example the Always On technology from Lenovo, China and the Intel ME technology from Intel.

With the function of the auxiliary system 702, in the embodiment of the present invention, the second connection setup unit 401 and the obtaining unit 402 as shown in FIG. 4 can be arranged on a specified system, i.e., the auxiliary system 702, in order to further improve the operation efficiency of the computer and prevent the process for acquiring the configuration information from affecting the operation efficiency of the computer. In this way, in the case where the computer is turned off but not powered off, the auxiliary system 702 obtains the desired configuration information from the server 703. The particular process for obtaining the configuration information is similar to the relevant process for obtaining the configuration information as shown in above FIG. 5 or 6, whose description is omitted here.

Further, the auxiliary system 702 can store the acquired configuration information in a relevant storage medium, such as a Random Access Memory (RAM), a Read-Only Memory (ROM) or a hard disk, such that the configuration information required for operating the BIOS program can be acquired from the relevant storage medium when the primary system 701 of the computer is started up. Reference is now made to FIG. 8, which is a flowchart showing a process in which a BIOS program acquires configuration information from the auxiliary system 702 according to an embodiment of the present invention. The process comprises the following steps.

At step 801, the BIOS program transmits a command to the auxiliary system 702 for requesting acquisition of the configuration information.

At step 802, on receipt of this command, the auxiliary system 702 gathers the configuration information from the storage medium and transmits it to the BIOS program.

At step 803, on receipt of the configuration information, the BIOS program performs relevant configuration operations.

Moreover, in practice, the BIOS program can be configured to directly access the auxiliary system 702 for acquiring the configuration information in the case where the BISO program is capable of directly accessing the auxiliary system 702.

Accordingly, a command transmission unit can be arranged in the computer to transmit to the auxiliary system 702 a command for requesting acquisition of the configuration information required by the configuration unit.

The auxiliary system 702 can comprise a command reception processing unit for receiving and executing the command.

In summary, with the method for configuring computer by BIOS, the server and the computer according to the embodiments of the present invention, the configuration information required by the computer is set on the server and then acquired by the computer from the server. Thus, it is more convenient in setting the configuration information, especially for the case where it is required to set the configuration information for a number of computers. In this way, the labor efficiency can be effectively improved.

Additionally, as the acquired configuration information can be temporarily stored in the computer, e.g., in a memory of the computer, the temporarily stored configuration information can be released after the operation of the BIOS program based on the configuration information is completed. In this way, the storage resource can be effectively saved. The storage medium for storing the configuration information, such as COMS and flash, can even be omitted in the computer in case of lack of resources.

Further, the configuration information is stored at the server end. Thus, in the case where the computer does not store the configuration information, it is difficult for a malicious access to illegally modify the configuration information applicable to the computer even if it can access the computer. Thus, the security of the configuration information can be effectively enhanced. On the other hand, in the case where the computer stores the configuration information in the memory, the computer can conveniently acquire the relevant configuration information from the server end again even if a malicious access has illegally modified the configuration information, without requiring the administrator to reset the relevant configuration information on the computer locally. In this way, the repetitive efforts by the administrator can be effectively avoided.

It can be appreciated by those who skilled in the art from the description of the above embodiments that the present invention can be implemented by software in combination of necessary general hardware platform or by hardware, but the former is preferred in many cases. Based on this understanding, the solution of the present invention or the part contributive to the prior art can be substantially embodied in software product. This computer software product can be stored in a storage medium and comprises several instructions for causing a computer device to implement the solutions according to various embodiments of the present invention.

The embodiments of the present invention also provide a system startup method and a computer system.

The embodiments of the present invention will be further detailed in the following with reference to the drawings and implementations, such that the solutions of the present invention can be better understood by those who skilled in the art.

In the prior art, a BIOS is typically stored in a flash chip dedicated for a computer system and typically relates to only one system. The embodiments of the present invention, however, differ from this in the following aspects.

First, the embodiments of the present invention are applied to a computer system comprising a primary system and an auxiliary system, e.g., an Always On computer system from Lenovo, a dual system having an Intel ME architecture or the like. Dual system is quite common in the related industry. For example, there are typically two sets of systems in a mobile phone, one for communication and the other for application processing such as photograph processing, notepad, etc.

In such a computer system, the primary system and the auxiliary system are typically two sets of systems independent of each other. These systems may or may not reside in the same housing.

Second, the BIOS program required for startup of the primary system is stored in a device on a network, e.g., a network server. The following embodiments will be explained taking the case where the BIOS program is stored in a network server as an example.

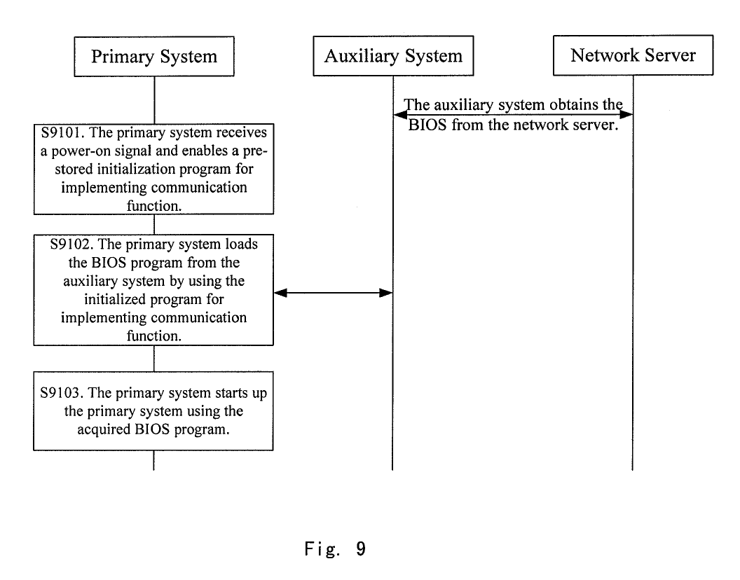

The first embodiment of the system startup method according to the present invention will be described in the following, where the auxiliary system can download in advance the BIOS from the network server and store it. Thus, when the primary system starts up, the flow as shown in FIG. 9 will be performed, which comprises the following steps.

At S9101, the primary system receives a power-on signal and enables a pre-stored initialization program for implementing communication function.

The power-on signal will be generated at the time of power-on. That is, if the power button on the housing is pressed by the user, the power-on signal will be generated. As such, the power source begins supplying the system main board and other devices.

The primary system receives the power-on signal via a signal line, and enables a pre-stored initialization program for implementing communication function. A BIOS in the prior art also comprises such initialization program for implementing communication function. However, in this embodiment, only the initialization program for implementing communication function, rather than the entire BIOS, can be pre-stored in the primary system.

In general, the voltage is not stable after initial power-on. Thus, the main board control chipset of the system will send and hold a reset signal to the CPU for initializing the CPU. After the power source begins supplying power stably, the chipset will cancel the reset signal. In the prior art, the CPU will jump to the actual startup code in the system BIOS immediately such that the CPU can further execute a series of initialization programs starting from the startup code. In the embodiment of the present invention, however, the system does not store the entire BIOS and the CPU will still jump to the initial code for a series of initialization programs, such as initialization programs for Power On Self Test (POST), graphics card BIOS, CPU and memory, and possibly an initialization program for enabling a Plug and Play device. These initialization programs will be briefly introduced in the following.

A main purpose of the POST initialization is to detect whether some key devices within the system, such as memory and graphics card, are present and normally operable. A complete POST process comprises tests for CPU, basic memory of 640K, extension memory of above 1M, ROM, main board, CMOS storage, serial/parallel port, graphics card, soft/hard disk subsystem and keyboard. If a problem is discovered during the self test, prompt information or a beep warning will be provided by the system.

The initialization of the graphics card BIOS comprises searching the BIOS for the graphics card. After finding the graphics card BIOS, the system invokes its initialization code and the graphics card BIOS initializes the graphics card. The system BIOS also searches BIOS programs for other devices and then invokes internal initialization codes for these BIOSs to initialize these devices.

Also, the system detects the type and operation frequency of the CPU as well as the memory. After the detection for the memory is passed, the system begins to detect some installed standard hardware devices, such as hardware, CD-ROM, keyboard, floppy drive, and devices for connections like serial port and parallel port. Further, in most cases, the system also automatically detects and sets a timing parameter for the memory as well as a parameter and access mode for the hard disk during this process.

After detection of the standard devices, internal codes of the system for supporting plug and play will begin to detect and configure the plug and play devices installed in the system. The system will assign resources such as interrupts, DMA channels and I/O ports to each device once it is found.

At S9102, the primary system loads the BIOS program from the auxiliary system by using the initialized program for implementing communication function.

The primary system acquires the BIOS program from the auxiliary system. The BIOS program can be downloaded from the auxiliary system and stored in the primary system.

In this step, the primary system can load the BIOS program from the auxiliary system into the primary system's memory via a bus interface by using the initialized communication function.

The BIOS stored in the auxiliary system can be a mirror BIOS. In this way, in loading the BIOS program from the auxiliary system into the primary system memory by using the initialized communication function, the primary system can load the mirror BIOS from the auxiliary system by using the initialized communication function and decompress the mirror BIOS into the primary system's memory.

In general, the system has installed therein a memory of a certain capacity, e.g., 128 MB, 256 MB, 512 MB or higher. An address is assigned to each byte of the memory such that the CPU can access the memory. The BIOS will occupy a certain segment of address space in the memory. As a simple example, for a 32 MB address range, which is represented in hexadecimal as 0-1FFFFFFH, the lowest 1 MB memory of 0-FFFFFH is very special since the memory accessible by the initial 8086 processor is only 1 MB at maximum. Herein, the lower 640 KB in this 1 MB is referred to as basic memory while the addresses of A0000H-BFFFFH are reserved for the graphics card and the addresses of C0000H-FFFFFH are reserved for the BIOS. The system BIOS typically occupies the space of the last 64 KB or more, the graphics card BIOS is typically at C0000H-C7FFFH and the BIOS for the IDE controller is at C8000H-CBFFFH. In the prior art, the space occupied by the BIOS in the memory is used by the host to load the BIOS from a storage device for storing the BIOS.

However, at S9102, the primary system loads the BIOS program into the primary system's memory from the auxiliary system, rather than from a storage device in the primary system for storing the BIOS. That is, in this embodiment, the primary system does not need to store the complete BIOS, which is necessary in the prior art.

At 59103, the primary system starts up the primary system using the acquired BIOS program.

The primary system can further accomplish system startup operation by using the BIOS loaded into the memory.

For example, the primary system may then update Extended System Configuration Data (ESCD) based on the BIOS in some cases. The ESCD refers to the data used by the system BIOS to exchange hardware configuration information with the operating system. The data can be stored in a COMS. Typically, the ESCD data will be updated only after a change in system hardware configuration occurs. Thus, the ESCD needs not to be updated each time the system starts up. However, the data format used by a system BIOS employing a certain chipset to store the ESCD data is different from that used by the operating system, e.g., Windows operating system. In this case, the Windows system will convert, during the startup process itself, the ESCD data into a format suitable for Windows, which will be converted back to the ESCD data format by the system BIOS during the next startup of the system (even if the hardware configuration does not change). Due to this cyclic operation, the system BIOS will update the ESCD once each time the computer starts up.

Further, the BIOS startup code may be started up from floppy disk, hard disk, optical drive and network in a certain startup order. For example, if the Windows operating system is started up from a hard disk (typically, disk C), the system BIOS will read and execute the main boot record in the hard disk, which then finds out the first active partition from the partition table. The system BIOS then reads and executes the partition boot record for this active partition, which then reads system files to start up the Windows system. Of course, if another operating system is installed, the main boot record can be replaced with a boot code corresponding to the another operating system.

In this embodiment, in downloading in advance the BIOS from the server and storing it, the auxiliary system can enable a program for downloading the BIOS from a network server and storing it each time the primary system is turned off or powered off according to the frequency for updating the BIOS. Alternatively, the auxiliary system can download the BIOS from the network server and store it according to a predetermined rule, e.g., according to a certain period or another rule.

It is to be noted that the above embodiment is applicable to a case in which there is a plurality of systems in a network and one or more systems (the primary system(s) thereof) are started up. If the BIOS for each system (the primary system thereof) is the same, the startup process for each system is similar to the above embodiment. However, if the BIOS for each system (the primary system thereof) is different from each other, the BIOS downloaded in advance from the server and stored by the auxiliary system of the system is the BIOS suitable for the corresponding primary system.

It can be seen from the above embodiment that the auxiliary system downloads in advance the BIOS from the server and stores it; the primary system receives a power-on signal and enables a pre-stored initialization program for implementing communication function; the primary system loads the BIOS program from the auxiliary system into the primary system memory by using the initialized communication function; and the primary system starts up the system using the BIOS program loaded into the memory. In this way, the capacity of the memory device dedicated for storing system BIOS in the primary system can be reduced.

It is also more convenient and easier to manage the BIOS, especially for the case where there are a number of identical systems in a network. In the prior art, the BIOS for each system needs to be managed and updated individually, which is troublesome. In particular, in each update, the action of refreshing flash is required for each computer. Thus, the operation is complicated for the user and the system may be prone to collapse during update of the BIOS due to refresh failure. With the above embodiment of the present invention, however, it is only required to manage the stored BIOS so as to manage the BIOS. In particular, in updating the BIOS, it is only required to replace the BIOS file on the server so as to update hundreds of, or even more, computers. Thus, the management and update for the BIOS can be facilitated.

Moreover, with the above embodiment, diversity in managing the BIOS in a network becomes possible. For example, the auxiliary system transmits to the network server a request for downloading the BIOS, which includes an identification of the primary system. The network server can return the BIOS corresponding to the primary system to the auxiliary system based on the identification of the primary system. As such, the auxiliary system stores the BIOS returned from the network server. Thus, according to the above embodiment, the primary system can be started up using the BIOS. Further, the BIOSs for different systems (primary systems) are stored in the network server in a centralized manner, such that the centralized management and maintenance for these BIOS can be facilitated.

In the following, the second embodiment of the system startup method according to the present invention will be explained, in which the primary system and the auxiliary system are both connected to a storage, the auxiliary system, after downloading in advance the BIOS from the server and storing it in the storage, maps an address in a primary system memory for loading the BIOS to an address in the storage for the downloaded BIOS and switches read/write function of the storage to the primary system.

In particular, the method comprises, in starting up the primary system:

performing system startup by reading the BIOS stored in the storage based on the mapping relationship between the BIOS program in the primary system's memory and the BIOS stored in the storage.

After receiving a power-on signal, the primary system reads the loaded BIOS from the memory to perform system startup. However, since the address in the memory for the loaded BIOS has been mapped to the address in the storage for the stored BIOS, as described above, the primary system will automatically switch to use the address in the storage for the stored BIOS when using the BIOS loaded into the memory, thereby performing the system startup.

In this way, with this embodiment, the complete BIOS can be stored in a third-party storage, rather than in the primary system as in the prior art.

As noted above, the primary system may then update Extended System Configuration Data (ESCD) based on the BIOS in some cases. The ESCD refers to the data used by the system BIOS to exchange hardware configuration information with the operating system. These data can be stored in a COMS. Typically, the ESCD data will be updated only after a change in system hardware configuration occurs. Thus, the ESCD needs not to be updated each time the system starts up. However, the data format used by a system BIOS employing a certain chipset to store the ESCD data is different from that used by the operating system, e.g., Windows operating system. In this case, the Windows system will convert, during the startup process of itself, the ESCD data into a format suitable for Windows, which will be converted back to the ESCD data format by the system BIOS during the next startup of the system even if the hardware configuration does not change. Due to this cyclic operation, the system BIOS will update the ESCD once each time the computer starts up.

Further, the BIOS startup code may be started up from floppy disk, hard disk, optical drive and network in a certain startup order. For example, if the Windows operating system is started up from a hard disk (typically, disk C), the system BIOS will read and execute the main boot record in the hard disk, which then finds out the first active partition from the partition table. The system BIOS then reads and executes the partition boot record for this active partition, which then reads system files to start up the Windows system. Of course, if another operating system is installed, the main boot record can be replaced with a boot code corresponding to the another operating system.

It can be seen from the above embodiment that the primary system and the auxiliary system are both connected to a storage; the auxiliary system, after downloading in advance the BIOS from the server and storing it in the storage, maps an address in a primary system's memory for loading the BIOS to an address in the storage for the downloaded BIOS and switches read/write function of the storage to the primary system; the primary system receives a power-on signal and performs system startup by reading the BIOS stored in the storage based on the mapping relationship between the BIOS program in the memory and the BIOS stored in the storage. In this way, the capacity of the memory device dedicated for storing system BIOS in the primary system can be reduced.

It is also more convenient and easier to manage the BIOS, especially for the case where there are a number of identical systems in a network. In the prior art, the BIOS for each system needs to be managed and updated individually, which is troublesome. In particular, in each update, the action of refreshing flash is required for each computer. Thus, the operation is complicated for the user and the system may be prone to collapse during update of the BIOS due to refresh failure. With the above embodiment of the present invention, however, it is only required to manage the stored BIOS so as to manage the BIOS. In particular, in updating the BIOS, it is only required to replace the BIOS file on the server so as to update hundreds of, or even more, computers. Thus, the management and update for the BIOS can be facilitated.

Moreover, with the above embodiment, diversity in managing the BIOS in a network becomes possible. For example, the auxiliary system transmits to the network server a request for downloading the BIOS, which includes an identification of the primary system. The network server can return the BIOS corresponding to the primary system to the auxiliary system based on the identification of the primary system. As such, the auxiliary system stores the BIOS returned from the network server. Thus, according to the above embodiment, the primary system can be started up using the BIOS. Further, the BIOSs for different systems (primary systems) are stored in the network server in a centralized manner, such that the centralized management and maintenance for these BIOS can be facilitated.

The storage comprises, but not limited to, Static Random Access Memory (SRAM), Dynamic Random Access Memory (DRAM), flash memory and magnetic disk.

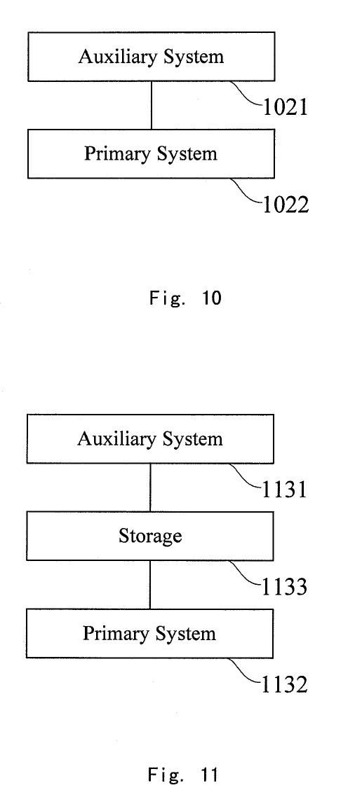

In the following, the first embodiment of the computer system according to the present invention will be explained. FIG. 10 shows the block diagram of the embodiment of the system. As shown in FIG. 10, the system is connected through a network to a server in the network, the server having a BIOS program stored therein. The computer system comprises:

an auxiliary system 1021 comprising a network connection module for obtaining the BIOS program from the server through the network and a storage module for storing the BIOS program; and

a primary system 1022 comprising a memory and an initialization module for implementing communication function;

wherein the primary system 1022 starts up the primary system using the BIOS program after loading the BIOS program into the memory by using the initialization module.

The method for implementing system startup with the above embodiment is similar to the first embodiment of the method as described above, whose description is omitted here.

In the following, the second embodiment of the computer system according to the present invention will be explained. FIG. 11 shows the block diagram of the embodiment of the system, in which the system is connected through a network to a device on the network, the device having a BIOS program stored therein. As shown in FIG. 11, the system comprises a primary system 1132, an auxiliary system 1131 and storage 1133. The BIOS program required for the startup of the primary system 1132 is stored in a network server and the primary system 1132 and the auxiliary system 1131 are both connected to the storage 1133.

The auxiliary system 1131 comprises:

a network connection unit configured to obtain the BIOS from the device and store it in the storage;

a mapping unit configured to map an address in a primary system's memory for loading the BIOS to an address in the storage for the downloaded BIOS; and

a switching unit configured to switch read/write function of the storage to the primary system.

The storage 1133 is configured to store the BIOS obtained by the auxiliary system 1131 from the server.

The primary system 1132 comprises a memory and an initialization module for implementing communication function.

Herein the primary system starts up the primary system using the BIOS program after loading the BIOS program into the memory by using the initialization module.

The method for implementing system startup with the above embodiment is similar to the second embodiment of the method as described above, whose description is omitted here.

While the foregoing has described the preferred embodiments of the present invention, it should be noted that those who skilled in the art can make various improvements and modifications without departing from the spirit of the present invention. These improvements and modifications are encompassed by the scope of the present invention as defined in the following claims.

1. A method for configuring a computer by Basic Input/Output System (BIOS), comprising the following steps of:
setting up a connection to a server storing configuration information for the computer through a network;
acquiring the configuration information for the computer from the server; and
configuring the computer based on the configuration information.

2. The method according to claim 1, wherein the step of acquiring the configuration information for the computer from the server comprises:
receiving the configuration information transmitted by the server.

3. The method according to claim 2, further comprising, prior to the step of receiving the configuration information transmitted by the server, the step of:
transmitting to the server a request message for requesting acquisition of the configuration information, the request message including a computer identification for identifying the computer.

4. The method according to claim 1, wherein the step of configuring the computer based on the configuration information comprises:
storing the configuration information temporarily; and
invoking the temporarily stored configuration information to configure the computer.

5. The method according to claim 4, further comprising, after the step of invoking the temporarily stored configuration information to configure the computer, the step of:
releasing the temporarily stored configuration information.

6. The method according to claim 1, wherein the step of configuring the computer based on the configuration information comprises:
storing the configuration information in a preset storage medium; and
invoking the configuration information from the storage medium to configure the computer.

7. The method according to claim 6, wherein the step of invoking the configuration information from the storage medium to configure the computer comprises:
invoking, during the current startup of the computer, the configuration information to configure the computer; or
invoking, during the next startup of the computer, the configuration information to configure the computer.

8. A server, comprising:
a first connection setup unit configured to set up a connection to a computer;
a storage unit configured to store configuration information for configuring the computer by BIOS; and
a data providing unit configured to provide the configuration information for the computer as stored in the storage unit to the computer via the connection set up by the first connection setup unit.

9. A computer, comprising:
a second connection setup unit configured to set up a connection to a server storing configuration information for configuring the computer by BIOS;
an obtaining unit configured to acquire the configuration information from the server via the connection set up by the second connection setup unit; and
a configuration unit configured to configure the computer based on the configuration information acquired by the obtaining unit.

10. The computer according to claim 9, wherein the second connection setup unit and the obtaining unit are arranged in a specified system in the computer.

11. A system startup method, which is applied to a computer system comprising a primary system and an auxiliary system, wherein BIOS program required for startup of the primary system is stored in a device in a network, the method comprising:
obtaining, by the auxiliary system, the BIOS program from the device through the network;
storing the BIOS program in the auxiliary system;
receiving, by the primary system, a power-on signal;
enabling, by the primary system, an initialization program for implementing communication function;
loading, by the primary system, the BIOS program from the auxiliary system by using the initialization program; and
starting up, by the primary system, the primary system using the BIOS program.

12. The method according to claim 11, wherein the step of the primary system loading the BIOS program from the auxiliary system by using the initialization program comprises:
loading, by the primary system, the BIOS program from the auxiliary system via a bus interface by using the initialized communication function.

13. The method according to claim 11, wherein the BIOS obtained by the auxiliary system comprises a mirror BIOS, and accordingly, the step of the primary system loading the BIOS program from the auxiliary system by using the initialization program comprises:
loading, by the primary system, the mirror BIOS from the auxiliary system by using the initialized communication function and decompressing the mirror BIOS into the primary system's memory.

14. The method according to claim 11, wherein the step of the auxiliary system obtaining the BIOS program from the device through the network comprises:
transmitting, by the auxiliary system, a request to a network server for downloading the BIOS, the request including an identification of the primary system;
returning, by a network device, the BIOS corresponding to the primary system to the auxiliary system based on the identification of the primary system; and
storing, by the auxiliary system, the BIOS returned from the network device.

15. The method according to claim 11, wherein the step of the auxiliary system obtaining the BIOS from the network device comprises:
obtaining, by the auxiliary system, the BIOS from a network device after the primary system is turned off or powered off according to a frequency for updating the BIOS; or
downloading, by the auxiliary system, the BIOS from a network server and storing it according to a predetermined rule.

16. A system startup method, which is applied to a computer system comprising a primary system and an auxiliary system, a BIOS program required for startup of the primary system being stored in a device in a network, wherein the primary system and the auxiliary system are both connected to a storage, the auxiliary system, after obtaining in advance the BIOS from the device and storing it in the storage, maps an address in a primary system's memory for loading the BIOS to an address in the storage for the downloaded BIOS and switches read/write function of the storage to the primary system, the method comprising:
receiving, by the primary system, a power-on signal and performing system startup by reading the BIOS stored in the storage based on a mapping relationship between the BIOS program in the primary system's memory and the BIOS stored in the storage.

17. The method according to claim 16, wherein the step of the auxiliary system obtaining the BIOS from the device and storing it in the server comprises:
transmitting, by the auxiliary system, a request to the device for downloading the BIOS, the request including an identification of the primary system;
returning, by the device, the BIOS corresponding to the primary system to the auxiliary system based on the identification of the primary system; and
storing, by the auxiliary system, the BIOS returned from the device in the storage.

18. The method according to claim 16, wherein the step of the auxiliary system obtaining in advance the BIOS from the device and storing it in the storage comprises:
obtaining, by the auxiliary system, the BIOS from the device after the primary system is turned off or powered off according to a frequency for updating the BIOS; or
downloading, by the auxiliary system, the BIOS from a network server and storing it according to a predetermined rule.

19. A computer system, which is connected through a network to a device in the network, the device having a BIOS program stored therein, the computer system comprising:
a primary system comprising a memory and an initialization module for implementing communication function; and
an auxiliary system comprising a network connection module for obtaining the BIOS program from the device through the network and a storage module for storing the BIOS program;
wherein the primary system starts up the primary system using the BIOS program after loading the BIOS program into the memory by using the initialization module.

20. A computer system, which comprises a primary system, an auxiliary system and a storage, wherein the system is connected through a network to a device in the network, the device having a BIOS program stored therein, the system comprising:
the auxiliary system, comprising:
a network connection unit configured to obtain the BIOS from the device and store it in the storage;
a mapping unit configured to map an address in a primary system's memory for loading the BIOS to an address in the storage for the downloaded BIOS; and
a switching unit configured to switch read/write function of the storage to the primary system;
the storage configured to store the BIOS obtained by the auxiliary system from the device; and
the primary system comprising a memory and an initialization module for implementing communication function;
wherein the primary system starts up the primary system using the BIOS program after loading the BIOS program into the memory by using the initialization module.

21. The method according to claim 2, wherein the step of configuring the computer based on the configuration information comprises:
storing the configuration information temporarily; and
invoking the temporarily stored configuration information to configure the computer.

22. The method according to claim 3, wherein the step of configuring the computer based on the configuration information comprises:
storing the configuration information temporarily; and
invoking the temporarily stored configuration information to configure the computer.
